(19) United States
(12) Patent Application Publication
(10) Pub. No.: US 2026/0165337 A1
(43) Pub. Date: Jun. 18, 2026

(54) INTELLIGENT CIRCULATING GREEN MAKING UNIT AND GREEN MAKING TECHNIQUE

(71) Applicants: Shandong Academy of Agricultural Sciences, Jinan (CN); Chichun Machinery (Xiamen) Co., Ltd., Xiamen (CN)

(72) Inventors: Chunwang DONG, Jinan (CN); Chunchi HUANG, Jinan (CN); Quansheng CHEN, Jinan (CN); Hui LIN, Jinan (CN)

(21) Appl. No.: 19/320,839

(22) Filed: Sep. 5, 2025

(30) Foreign Application Priority Data
Dec. 13, 2024 (CN) 202411834605.0

(51) Int. Cl. A23F 3/06; A23N 12/08; B65G 15/00; G06T 7/00; G06T 7/90

(52) U.S. Cl. CPC A23F 3/06; A23N 12/08; B65G 15/00; G06T 7/001; G06T 7/90; B65G 2201/04; B65G 2203/041; G06T 2207/10024; G06T 2207/30128

(57) ABSTRACT

An intelligent circulating green making unit and a green making technique include a first rocking unit, a first withering unit, a second rocking unit, a second withering unit, a third rocking unit and a fourth rocking unit. The present disclosure connects the first rocking unit, the first withering unit, the second rocking unit, the second withering unit, the third rocking unit and the fourth rocking unit sequentially, realizing the automation of the green making process; the alternation of rocking and withering improves the green making effect and enhances the yield of the tea; the gear ring is driven by the driving gear to drive the rotary rocking machine to rotate, so that the automation of the rotary rocking machine is realized, the problem of the fluctuation of the manual rocking rate is reduced and the rocking of the tea is more stable and uniform.

### CROSS-REFERENCE TO RELATED APPLICATION

This patent application claims the benefit and priority of Chinese Patent Application No. 202411834605.0, entitled “INTELLIGENT CIRCULATING GREEN MAKING UNIT AND GREEN MAKING TECHNIQUE” filed with the China National Intellectual Property Administration on Dec. 13, 2024, the disclosure of which is incorporated by reference herein in its entirety as part of the present application.

### TECHNICAL FIELD

The present disclosure belongs to the technical field of tea preparation, and particularly relates to an intelligent circulating green making unit and a green making technique.

### BACKGROUND

Green making is one of the unique processes of making Oolong tea. Green making can properly regulate the evaporation of water and the self-decomposition of inclusions in the process of withering. Under the action of mechanical force, some tissues of leaf margin cells of the making green leaves were damaged, which promoted the oxidation, polymerization and condensation of polyphenolic compounds, produced colored substances and promoted the formation of aromatic compounds. Green making consists of two processes: rocking and withering. In the process of rocking, the leaf tissues enhance the water absorption capacity of the cells due to vibration, improving the transport function of the conducting tissues. The water in the stem is transported to the leaves through the leaf veins, and the aromatic substances in the stem are transferred to the leaves with the water. The water evaporates from the leaf surface, and the water-soluble substances accumulate in the leaves. Due to the infiltration of water from the stem veins to the leaves, the leaves return to their swollen state after rocking, which is called returning green, commonly known as returning Yang. After rocking, it enters withering, which is also called resting, awaiting oxidation and spreading. In the process of withering, the making green leaves are in a relatively stopped state, the leaves continue to evaporate water, the leaves lose more water, the stems lose less water, and the leaves are in a withered state, which is called the fading of the green color. In the process of green making, the leaves undergo a chemical change of withering, the green gradually decreases, and the edge gradually turns red. Through the alternation of 5 to 7 times of rocking and withering, when the leaves are red at the edge, green in the middle, transparent in the veins, shaped like a spoon, stiff in appearance, soft in hand feeling, and emit strong osmanthus fragrance, it is considered to be moderately green making.

However, due to the different particle sizes of tea grains or different producing areas of tea, the time of rocking and withering can not be accurately guaranteed, which leads to the low yield of tea, so it is urgent to propose a green making unit which can automatically adjust the withering time for tea.

### SUMMARY

The present disclosure provides an intelligent circulating green making unit and a green making technique which can effectively solve the above problems.

The present disclosure is implemented as follows.

An intelligent circulating green making unit includes a first rocking unit, a first withering unit, a second rocking unit, a second withering unit, a third rocking unit and a fourth rocking unit.

The first rocking unit, in which a first camera module is arranged, the first rocking unit includes two sets of first rotary rocking machines connected end to end, the first rotary rocking machine includes a first mounting rack, the first mounting rack is provided with a plurality of sets of first rotary wheels, and the first rotary rocking machine is provided with a plurality of sets of first limiting grooves and the first limiting groove is adapted with the first rotary wheel.

The first withering unit, wherein the feeding end of the first withering unit is communicated with the discharging end of the first rocking unit through a conveying assembly, the first withering unit is a single-layer withering machine, the single-layer withering machine includes a first frame, three sets of first transmission belt assemblies are arranged inside the first frame at intervals along the vertical direction, and the transmission distances of the three sets of the first transmission belt assemblies are sequentially lengthened from top to bottom, and the transmission directions of two adjacent sets of the first transmission belt assemblies are opposite.

The second rocking unit, in which a second camera module is arranged, the feeding end of the second rocking unit is communicated with the discharging end of the first withering unit through a conveying assembly, the second rocking unit includes two sets of second rotary rocking machines connected end to end, the second rotary rocking machine includes a second mounting rack, the second mounting rack is provided with a plurality of sets of second rotary wheels, and the second rotary rocking machine is provided with a plurality of sets of second limiting grooves and the second limiting groove is adapted with the second rotary wheel.

The second withering unit, wherein the feeding end of the second withering unit is communicated with the discharging end of the second rocking unit through a conveying assembly, the second withering unit includes a plurality of sets of three-layer withering machines, the plurality of sets of three-layer withering machines include a second frame, and three sets of second transmission belt assemblies are arranged inside the second frame at intervals along the vertical direction, and the transmission distances of the three sets of the second transmission belt assemblies are sequentially lengthened from top to bottom, and the transmission directions of two adjacent sets of the second transmission belt assemblies are opposite; the second transmission belt assembly positioned at the lowest end of the second frame is provided with a lifting assembly, the feeding end of the lifting assembly is communicated with the second transmission belt assembly positioned at the lowest end of the second frame, the discharging end of the lifting assembly is communicated with the feeding end of the next set of the second transmission belt assembly positioned at the uppermost end of the second frame.

The third rocking unit, in which a third camera module is arranged, the feeding end of the third rocking unit is communicated with the discharging end of the second withering unit through a conveying assembly, the third rocking unit includes two sets of third rotary rocking machines connected end to end, the third rotary rocking machine includes a third mounting rack, the third mounting rack is provided with a plurality of sets of third rotary wheels, and the third rotary rocking machine is provided with a plurality of sets of third limiting grooves and the third limiting groove is adapted with the third rotary wheel.

The fourth rocking unit, wherein the feeding end of the fourth rocking unit is communicated with the discharging end of the third rocking unit through a conveying assembly, the fourth rocking unit includes a fourth rotary rocking machines, the fourth rotary rocking machine includes a fourth mounting rack, the fourth mounting rack is provided with a plurality of sets of fourth rotary wheels, and the fourth rotary rocking machine is provided with a plurality of fourth limiting grooves and the fourth limiting groove is adapted with the fourth rotary wheel.

As a further improvement, the outer surface of the first rotary rocking machine is further provided with a first gear ring, the first mounting rack is further provided with a first driving gear, and the first gear ring is meshed with the first driving gear.

As a further improvement, the outer surface of the second rotary rocking machine is further provided with a second gear ring, the second mounting rack is further provided with a second driving gear, and the second gear ring is meshed with the second driving gear.

As a further improvement, the outer surface of the third rotary rocking machine is further provided with a third gear ring, the third mounting rack is further provided with a third driving gear, and the third gear ring is meshed with the third driving gear.

As a further improvement, the outer surface of the fourth rotary rocking machine is further provided with a fourth gear ring, the fourth mounting rack is further provided with a fourth driving gear, and the fourth gear ring is meshed with the fourth driving gear.

A green making technique of the intelligent circulating green making unit includes the following steps.

For the first rocking, the withered tea are transported to the feeding end of the first rotary rocking machine through a conveying assembly. The first driving gear is driven to rotate according to the preset rotary time and rotary rate, which in turn drives the first gear ring to rotate, thus starting the first rocking technique of the first rotary rocking machine.

For the first photography analysis, the first camera module takes photos of the tea after the first rocking, and sends the photos to the first processor. After receiving the photos, the first processor extracts and analyzes the tea color degree in the photos. Finally, the extracted and analyzed tea color degree is compared and analyzed with the preset standard tea color degree. If the extracted and analyzed tea color degree is weaker than the preset standard tea color degree, the subsequent drying time of the single-layer withering unit will be increased. If the extracted and analyzed tea color degree is higher than the preset standard tea color degree, the subsequent drying time of the single-layer withering unit will be reduced.

For the first withering, the transmission rate of the first transmission belt assembly is regulated according to the control command issued by the first processor. After the first transmission belt assembly is regulated, the tea is transported to the first transmission belt assembly on the uppermost layer from the discharge end of the first rotary rocking machine through the conveying assembly, transported sequentially to the first transmission belt assembly on the lowest layer through the first transmission belt assembly on the uppermost layer and transported to the feeding end of the second rotary rocking machine from the first transmission belt assembly on the lowest layer through the conveying assembly.

For the second rocking, the second driving gear is driven to rotate according to the preset rotary time and rotary rate, which in turn drives the second gear ring to rotate, thus starting the second rocking technique of the second rotary rocking machine.

For the second photography analysis, the second camera module takes photos of the tea after the second rocking, and sends the photos to the second processor. After receiving the photos, the second processor extracts and analyzes the tea color degree in the photos. Finally, the extracted and analyzed tea color degree is compared and analyzed with the preset standard tea color degree. If the extracted and analyzed tea color degree is weaker than the preset standard tea color degree, the subsequent drying time of the three-layer withering unit will be increased. If the extracted and analyzed tea color degree is higher than the preset standard tea color degree, the subsequent drying time of the three-layer withering unit will be reduced.

For the second withering, the transmission rate of the second transmission belt assembly is regulated according to the control command issued by the second processor. After the second transmission belt assembly is regulated, the tea is transported to the second transmission belt assembly on the uppermost layer from the discharge end of the second rotary rocking machine through the conveying assembly, and transported sequentially to the second transmission belt assembly on the lowest layer through the second transmission belt assembly on the uppermost layer; then, the tea positioned at the second transmission belt assembly on the lowest layer is lifted to the next set of the second transmission belt assembly on the uppermost layer through the lifting assembly, and transported repeatedly to the second transmission belt assembly on the lowest layer from the second transmission belt assembly on the uppermost layer.

For the third rocking, the third driving gear is driven to rotate according to the preset rotary time and rotary rate, which in turn drives the third gear ring to rotate, thus starting the third rocking technique of the third rotary rocking machine.

For the third photography analysis, the third camera module takes photos of the tea after the third rocking, and sends the photos to the third processor. After receiving the photos, the third processor extracts and analyzes the tea color degree in the photos. Finally, the extracted and analyzed tea color degree is compared and analyzed with the preset standard tea color degree. If the extracted and analyzed tea color degree is weaker than the preset standard tea color degree, the subsequent rocking time of the fourth rocking unit will be increased or the subsequent rocking force of the fourth rocking unit will be enhanced. If the extracted and analyzed tea color degree is higher than the preset standard tea color degree, the subsequent rocking time of the fourth rocking unit will be reduced or the subsequent rocking force of the fourth rocking unit will be weakened.

For the fourth rocking, the rotary rate of the fourth driving gear is regulated according to the control command issued by the third processor. After the rotary rate of the fourth driving gear is regulated, the tea is transported to the feeding end of the fourth rocking unit from the discharge end of the third rocking unit through the conveying assembly, and then the fourth driving gear is driven to rotate, which in turn drives the fourth gear ring to rotate, thus starting the forth rocking technique of the forth rotary rocking machine.

As a further improvement, the first photography analysis specifically includes:

If the extracted and analyzed tea color degree is weaker than the preset standard tea color degree by less than three color degrees, the standard drying time of the single-layer withering unit shall be increased by 10%. If the extracted and analyzed tea color degree is weaker than the preset standard tea color degree by not less than three color degrees, the standard drying time of the single-layer withering unit shall be increased by 30%.

If the extracted and analyzed tea color degree is higher than the preset standard tea color degree by less than three color degrees, the standard drying time of the single-layer withering unit shall be reduced by 20%. If the extracted and analyzed tea color degree is higher than the preset standard tea color degree by not less than three color degrees, the standard drying time of the single-layer withering unit shall be reduced by 45%.

As a further improvement, the second photography analysis specifically includes:

If the extracted and analyzed tea color degree is weaker than the preset standard tea color degree by less than three color degrees, the standard drying time of the three-layer withering unit shall be increased by 5%. If the extracted and analyzed tea color degree is weaker than the preset standard tea color degree by not less than three color degrees, the standard drying time of the three-layer withering unit shall be increased by 25%.

If the extracted and analyzed tea color degree is higher than the preset standard tea color degree by less than three color degrees, the standard drying time of the three-layer withering unit shall be reduced by 8%. If the extracted and analyzed tea color degree is higher than the preset standard tea color degree by not less than three color degrees, the standard drying time of the three-layer withering unit shall be reduced by 33%.

As a further improvement, the third photography analysis specifically includes:

If the extracted and analyzed tea color degree is weaker than the preset standard tea color degree by less than three color degrees, the standard rocking time or the standard rocking force of the fourth rocking unit shall be increased by 15%. If the extracted and analyzed tea color degree is weaker than the preset standard tea color degree by not less than three color degrees, the standard rocking time or the standard rocking force of the fourth rocking unit shall be increased by 25%.

If the extracted and analyzed tea color degree is higher than the preset standard tea color degree by less than three color degrees, the standard rocking time or the standard rocking force of the fourth rocking unit shall be reduced by 28%. If the extracted and analyzed tea color degree is higher than the preset standard tea color degree by not less than three color degrees, the standard rocking time or the standard rocking force of the fourth rocking unit shall be reduced by 38%.

The beneficial effects of the present disclosure are as follows: the first rocking unit, the first withering unit, the second rocking unit, the second withering unit, the third rocking unit and the fourth rocking unit are sequentially connected through the conveying assembly, realizing the automation of the green making process. Secondly, the alternation of rocking and withering improves the green making effect of tea and enhances the yield of the tea. The gear ring is driven by the driving gear to drive the rotary rocking machine to rotate, so that the automation of the rotary rocking machine is realized, the problem of the fluctuation of the manual rocking rate is reduced and the rocking of the tea is more stable and uniform.

Other features and advantages of the present disclosure will be described in the following specification, and in part will become apparent from the specification, or may be learned by practicing embodiments of the present disclosure. The objectives and other advantages of the present disclosure can be achieved and obtained through the structures specifically indicated in the written specification, claims, and drawings.

### BRIEF DESCRIPTION OF THE DRAWINGS

In order to more clearly illustrate the technical solutions of the embodiments of the present disclosure, the accompanying drawings used in the embodiments will now be described briefly. It should be understood that the drawings in the following description are only the embodiment of the present disclosure and should not be considered as limiting the scope, and those skilled in the art can obtain other other relevant drawings based on these drawings without creative efforts.

FIG. 1 is a schematic diagram of the overall structure of the intelligent circulating green making unit and the green making technique of the present disclosure;

FIG. 2 is an enlarged schematic diagram of the structure of A in FIG. 1; and

FIG. 3 is an enlarged schematic diagram of the structure of B in FIG. 1.

### REFERENCE NUMBER

1—first rocking unit, 101—first mounting rock, 102—first rotary wheel, 103—first rotary rocking machine, 104—first gear ring, 105—first limiting groove, 2—first withering unit, 201—first frame, 202—first transmission belt assembly, 3—second rocking unit, 4—second withering unit, 5—third rocking unit and 6—fourth rocking unit.

### DETAILED DESCRIPTION OF THE EMBODIMENTS

In order to make the objectives, technical solutions, and advantages of the embodiments of the present disclosure more obvious, the technical solutions in the embodiments of the present disclosure will be clearly and completely described in conjunction with the accompanying drawings in the embodiments of the present disclosure. Obviously, the described embodiments are only a part of the embodiments of the present disclosure, but not all the embodiments thereof. Based on the embodiments of the present disclosure. Based on the embodiments of the present disclosure, all other embodiments obtained by those skilled in the art without any creative efforts shall fall within the protection scope of the present disclosure. Therefore, the detailed description of the embodiments of the present disclosure provided in the accompanying drawings is not intended to limit the scope of the present disclosure, but only to represent selected embodiments of the present disclosure. Based on the embodiments of the present disclosure, all other embodiments obtained by those skilled in the art without any creative efforts are within the protection scope of the present disclosure.

In the description of the present disclosure, the terms “up”, “lower”, “above”, “two ends”, etc., indicating an orientation or positional relationship are based on the orientation or positional relationship shown in the accompanying drawings only for the convenience of describing the present disclosure and simplifying the description, and do not indicate or imply that the referred devices or referred elements must have a specific orientation, be constructed and operated in a specific orientation, and therefore are not to be construed as limiting the present disclosure.

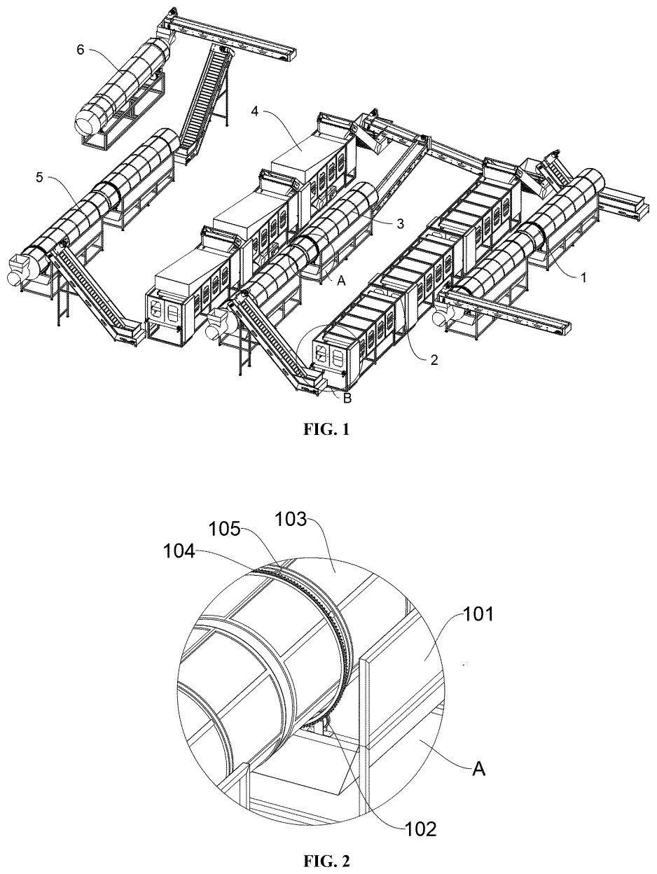

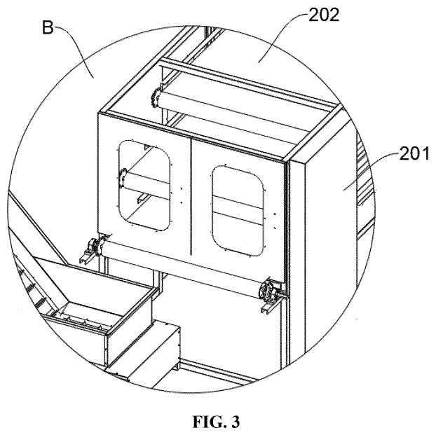

As shown in FIGS. 1-3, the embodiment provides an intelligent circulating green making unit, which includes a first rocking unit 1, a first withering unit 2, a second rocking unit 3, a second withering unit 4, a third rocking unit 5 and a fourth rocking unit 6.

The first camera module is arranged in the first rocking unit 1. The first rocking unit 1 includes two sets of the first rotary rocking machines 103 connected end to end, the first rotary rocking machine 103 includes the first mounting rack 101, the first mounting rack 101 is provided with a plurality of sets of the first rotary wheels 102, and the first rotary rocking machine 103 is provided with a plurality of sets of the first limiting grooves 105 and the first limiting groove 105 is adapted with the first rotary wheel 102.

The feeding end of the first withering unit 2 is communicated with the discharging end of the first rocking unit 1 through a conveying assembly, the first withering unit 2 is a single-layer withering machine, the single-layer withering machine includes the first frame 201, three sets of the first transmission belt assemblies 202 are arranged inside the first frame 201 at intervals along the vertical direction, and the transmission distances of the three sets of the first transmission belt assemblies 202 are sequentially lengthened from top to bottom, and the transmission directions of the two adjacent sets of the first transmission belt assemblies 202 are opposite.

The second camera module is arranged in the second rocking unit 3, the feeding end of the second rocking unit 3 is communicated with the discharging end of the first withering unit 2 through a conveying assembly, the second rocking unit 3 includes two sets of second rotary rocking machines connected end to end, the second rotary rocking machine includes the second mounting rack, the second mounting rack is provided with a plurality of sets of the second rotary wheels, and the second rotary rocking machine is provided with a plurality of sets of the second limiting grooves and the second limiting groove is adapted with the second rotary wheel.

The feeding end of the second withering unit 4 is communicated with the discharging end of the second rocking unit 3 through a conveying assembly, the second withering unit 4 includes a plurality of sets of three-layer withering machines, the plurality of sets of three-layer withering machines include the second frame, and three sets of the second transmission belt assemblies are arranged inside the second frame at intervals along the vertical direction, and the transmission distances of the three sets of the second transmission belt assemblies are sequentially lengthened from top to bottom, and the transmission directions of the two adjacent sets of the second transmission belt assemblies are opposite; the second transmission belt assembly positioned at the lowest end of the second frame is provided with a lifting assembly, the feeding end of the lifting assembly is communicated with the second transmission belt assembly positioned at the lowest end of the second frame, the discharging end of the lifting assembly is communicated with the feeding end of the next set of the second transmission belt assembly positioned at the uppermost end of the second frame.

The third camera module is arranged in the third rocking unit 5, the feeding end of the third rocking unit 5 is communicated with the discharging end of the second withering unit 4 through a conveying assembly, the third rocking unit 5 includes two sets of the third rotary rocking machines connected end to end, the third rotary rocking machine includes the third mounting rack, the third mounting rack is provided with a plurality of sets of third rotary wheels, and the third rotary rocking machine is provided with a plurality of sets of the third limiting grooves and the third limiting groove is adapted with the third rotary wheel.

The feeding end of the fourth rocking unit 6 is communicated with the discharging end of the third rocking unit through a conveying assembly, the fourth rocking unit includes a fourth rotary rocking machines, the fourth rotary rocking machine include a fourth mounting rack, the fourth mounting rack is provided with a plurality of sets of fourth rotary wheels, and the fourth rotary rocking machine is provided with a plurality of fourth limiting grooves and the fourth limiting groove is adapted with the fourth rotary wheel.

The first rocking unit 1, the first withering unit 2, the second rocking unit 3, the second withering unit 4, the third rocking unit 5 and the fourth rocking unit 6 are sequentially connected through the conveying assembly, realizing the automation of the green making process, then the alternation of rocking and withering improves the green making effect of tea and enhances the yield of the tea.

Furthermore, the outer surface of the first rotary rocking machine 103 is further provided with the first gear ring 104, the first mounting rack 101 is further provided with the first driving gear, and the first gear ring 104 is meshed with the first driving gear. The outer surface of the second rotary rocking machine is further provided with the second gear ring, the second mounting rack is further provided with the second driving gear, and the second gear ring is meshed with the second driving gear. The outer surface of the third rotary rocking machine is further provided with the third gear ring, the third mounting rack is further provided with the third driving gear, and the third gear ring is meshed with the third driving gear. The outer surface of the fourth rotary rocking machine is further provided with the fourth gear ring, the fourth mounting rack is further provided with the fourth driving gear, and the fourth gear ring is meshed with the fourth driving gear.

The gear ring is driven by the driving gear to drive the rotary rocking machine to rotate, so that the automation of the rotary rocking machine is realized, so that the problem of the fluctuation of the manual rocking rate is reduced and the rocking of the tea is more stable and uniform.

The green making technique of the intelligent circulating green making unit is applied to any one of the intelligent circulating green making units, and the green making technique includes the following steps: the first rocking, the first photography analysis, the first withering, the second rocking, the second photography analysis, the second withering, the third rocking, the third photography analysis and the fourth rocking.

For the first rocking, the withered tea are transported to the feeding end of the first rotary rocking machine 103 through a conveying assembly. The first driving gear is driven to rotate according to the preset rotary time and rotary rate, which in turn drives the first gear ring 104 to rotate, thus starting the first rocking technique of the first rotary rocking machine 103.

For the first photography analysis, the first camera module takes photos of the tea after the first rocking, and sends the photos to the first processor. After receiving the photos, the first processor extracts and analyzes the tea color degree in the photos. Finally, the extracted and analyzed tea color degree is compared and analyzed with the preset standard tea color degree. If the extracted and analyzed tea color degree is weaker than the preset standard tea color degree, the subsequent drying time of the single-layer withering unit will be increased. If the extracted and analyzed tea color degree is higher than the preset standard tea color degree, the subsequent drying time of the single-layer withering unit will be reduced.

For the first withering, the transmission rate of the first transmission belt assembly 202 is regulated according to the control command issued by the first processor. After the first transmission belt assembly 202 is regulated, the tea is transported to the first transmission belt assembly 202 on the uppermost layer from the discharge end of the first rotary rocking machine 103 through the conveying assembly, transported sequentially to the first transmission belt assembly 202 on the lowest layer through the first transmission belt assembly 202 on the uppermost layer and transported to the feeding end of the second rotary rocking machine from the first transmission belt assembly 202 on the lowest layer through the conveying assembly.

For the second rocking, the second driving gear is driven to rotate according to the preset rotary time and rotary rate, which in turn drives the second gear ring to rotate, thus starting the second rocking technique of the second rotary rocking machine.

For the second photography analysis, the second camera module takes photos of the tea after the second rocking, and sends the photos to the second processor. After receiving the photos, the second processor extracts and analyzes the tea color degree in the photos. Finally, the extracted and analyzed tea color degree is compared and analyzed with the preset standard tea color degree. If the extracted and analyzed tea color degree is weaker than the preset standard tea color degree, the subsequent drying time of the three-layer withering unit will be increased. If the extracted and analyzed tea color degree is higher than the preset standard tea color degree, the subsequent drying time of the three-layer withering unit will be reduced.

For the second withering, the transmission rate of the second transmission belt assembly is regulated according to the control command issued by the second processor. After the second transmission belt assembly is regulated, the tea is transported to the second transmission belt assembly on the uppermost layer from the discharge end of the second rotary rocking machine through the conveying assembly, and transported sequentially to the second transmission belt assembly on the lowest layer through the second transmission belt assembly on the uppermost layer; then, the tea positioned at the second transmission belt assembly on the lowest layer is lifted to the next set of the second transmission belt assembly on the uppermost layer through the lifting assembly, and transported repeatedly to the second transmission belt assembly on the lowest layer from the second transmission belt assembly on the uppermost layer.

For the third rocking, the third driving gear is driven to rotate according to the preset rotary time and rotary rate, which in turn drives the third gear ring to rotate, thus starting the third rocking technique of the third rotary rocking machine.

For the third photography analysis, the third camera module takes photos of the tea after the third rocking, and sends the photos to the third processor. After receiving the photos, the third processor extracts and analyzes the tea color degree in the photos. Finally, the extracted and analyzed tea color degree is compared and analyzed with the preset standard tea color degree. If the extracted and analyzed tea color degree is weaker than the preset standard tea color degree, the subsequent rocking time of the fourth rocking unit will be increased or the subsequent rocking force of the fourth rocking unit will be enhanced. If the extracted and analyzed tea color degree is higher than the preset standard tea color degree, the subsequent rocking time of the fourth rocking unit will be reduced or the subsequent rocking force of the fourth rocking unit will be weakened.

For the fourth rocking, the rotary rate of the fourth driving gear is regulated according to the control command issued by the third processor. After the rotary rate of the fourth driving gear is regulated, the tea is transported to the feeding end of the fourth rocking unit from the discharge end of the third rocking unit through the conveying assembly, and then the fourth driving gear is driven to rotate, which in turn drives the fourth gear ring to rotate, thus starting the forth rocking technique of the forth rotary rocking machine.

Color analysis is carried out on the tea subjected to different shaking times through the photographing module, so that the time and the power of subsequent process can be adjusted according to the tea with different rocking degrees, different particle sizes and different producing areas, the finally produced tea can further meet the standard, and the yield of the finally produced tea is greatly enhanced.

Furthermore, the first photography analysis specifically includes:

If the extracted and analyzed tea color degree is weaker than the preset standard tea color degree by less than three color degrees, the standard drying time of the single-layer withering unit shall be increased by 10%, and if the extracted and analyzed tea color degree is weaker than the preset standard tea color degree by not less than three color degrees, the standard drying time of the single-layer withering unit shall be increased by 30%.

If the extracted and analyzed tea color degree is higher than the preset standard tea color degree by less than three color degrees, the standard drying time of the single-layer withering unit shall be reduced by 20%. If the extracted and analyzed tea color degree is higher than the preset standard tea color degree by not less than three color degrees, the standard drying time of the single-layer withering unit shall be reduced by 45%.

By using the first camera module to analyze the color of the tea after the first rocking, and adjusting the values of the single-layer withering unit according to the difference in color degrees, the tea produced by the single-layer withering unit can meet the standard values of the tea after the first withering as much as possible.

Furthermore, the second photography analysis specifically includes:

If the extracted and analyzed tea color degree is weaker than the preset standard tea color degree by less than three color degrees, the standard drying time of the three-layer withering unit shall be increased by 5%. If the extracted and analyzed tea color degree is weaker than the preset standard tea color degree by not less than three color degrees, the standard drying time of the three-layer withering unit shall be increased by 25%.

If the extracted and analyzed tea color degree is higher than the preset standard tea color degree by less than three color degrees, the standard drying time of the three-layer withering unit shall be reduced by 8%. If the extracted and analyzed tea color degree is higher than the preset standard tea color degree by not less than three color degrees, the standard drying time of the three-layer withering unit shall be reduced by 33%.

By using the second camera module to analyze the color of the tea after the second rocking, and adjusting the values of the three-layer withering unit according to the difference in color degrees, the tea produced by the three-layer withering unit can meet the standard values of the tea after the second withering as much as possible.

Furthermore, the third photography analysis specifically includes:

If the extracted and analyzed tea color degree is weaker than the preset standard tea color degree by less than three color degrees, the standard rocking time or the standard rocking force of the fourth rocking unit shall be increased by 15%. If the extracted and analyzed tea color degree is weaker than the preset standard tea color degree by not less than three color degrees, the standard rocking time or the standard rocking force of the fourth rocking unit shall be increased by 25%.

If the extracted and analyzed tea color degree is higher than the preset standard tea color degree by less than three color degrees, the standard rocking time or the standard rocking force of the fourth rocking unit shall be reduced by 28%. If the extracted and analyzed tea color degree is higher than the preset standard tea color degree by not less than three color degrees, the standard rocking time or the standard rocking force of the fourth rocking unit shall be reduced by 38%.

By using the third camera module to analyze the color of the tea after the third rocking, and adjusting the values of the forth rocking unit 6 according to the difference in color degrees, the tea produced by the forth rocking unit 6 can meet the standard values of the tea after the complete rocking process as much as possible, thereby ensuring the yield of tea.

The above description is only a preferred embodiment of the present disclosure and is not intended to limit the present disclosure. For those skilled in the art, the present disclosure may have various modifications and variations. Any modifications, equivalent substitutions, improvements, etc. made within the spirit and principles of the present disclosure shall be included within the protection scope of the present disclosure.

What is claimed is:

1. An intelligent circulating green making unit, comprising:
a first rocking unit, in which a first camera module is arranged, the first rocking unit comprises two sets of first rotary rocking machines connected end to end, the first rotary rocking machine comprises a first mounting rack, the first mounting rack is provided with a plurality of sets of first rotary wheels, and the first rotary rocking machine is provided with a plurality of sets of first limiting grooves and the first limiting groove is adapted with the first rotary wheel;
a first withering unit, wherein a feeding end of the first withering unit is communicated with a discharging end of the first rocking unit through a conveying assembly, the first withering unit is a single-layer withering machine, the single-layer withering machine comprises a first frame, three sets of first transmission belt assemblies are arranged inside the first frame at intervals along a vertical direction, and transmission distances of the three sets of the first transmission belt assemblies are sequentially lengthened from top to bottom, and transmission directions of two adjacent sets of the first transmission belt assemblies are opposite;
a second rocking unit, in which a second camera module is arranged, a feeding end of the second rocking unit is communicated with a discharging end of the first withering unit through a conveying assembly, the second rocking unit comprises two sets of second rotary rocking machines connected end to end, the second rotary rocking machine comprises a second mounting rack, the second mounting rack is provided with a plurality of sets of second rotary wheels, the second rotary rocking machine is provided with a plurality of sets of second limiting grooves and the second limiting groove is adapted with the second rotary wheel;
a second withering unit, wherein a feeding end of the second withering unit is communicated with a discharging end of the second rocking unit through a conveying assembly, the second withering unit comprises a plurality of sets of three-layer withering machines, the plurality of sets of three-layer withering machines comprise a second frame, and three sets of second transmission belt assemblies are arranged inside the second frame at intervals along a vertical direction, and transmission distances of the three sets of the second transmission belt assemblies are sequentially lengthened from top to bottom, and transmission directions of two adjacent sets of the second transmission belt assemblies are opposite; the second transmission belt assembly positioned at a lowest end of the second frame is provided with a lifting assembly, a feeding end of the lifting assembly is communicated with the second transmission belt assembly positioned at a lowest end of the second frame, a discharging end of the lifting assembly is communicated with a feeding end of a next set of the second transmission belt assembly positioned at an uppermost end of the second frame;
a third rocking unit, in which a third camera module is arranged, a feeding end of the third rocking unit is communicated with a discharging end of the second withering unit through a conveying assembly, the third rocking unit comprises two sets of third rotary rocking machines connected end to end, the third rotary rocking machine comprises a third mounting rack, the third mounting rack is provided with a plurality of sets of third rotary wheels, the third rotary rocking machine is provided with a plurality of sets of third limiting grooves and the third limiting groove is adapted with the third rotary wheel; and
a fourth rocking unit, wherein a feeding end of the fourth rocking unit is communicated with a discharging end of the third rocking unit through a conveying assembly, the fourth rocking unit comprises a fourth rotary rocking machines, the fourth rotary rocking machine comprises a fourth mounting rack, the fourth mounting rack is provided with a plurality of sets of fourth rotary wheels, the fourth rotary rocking machine is provided with a plurality of fourth limiting grooves and the fourth limiting groove is adapted with the fourth rotary wheel.

2. The intelligent circulating green making unit according to claim 1, wherein an outer surface of the first rotary rocking machine is further provided with a first gear ring, the first mounting rack is further provided with a first driving gear, and the first gear ring is meshed with the first driving gear.

3. The intelligent circulating green making unit according to claim 1, wherein an outer surface of the second rotary rocking machine is further provided with a second gear ring, the second mounting rack is further provided with a second driving gear, and the second gear ring is meshed with the second driving gear.

4. The intelligent circulating green making unit according to claim 1, wherein an outer surface of the third rotary rocking machine is further provided with a third gear ring, the third mounting rack is further provided with a third driving gear, and the third gear ring is meshed with the third driving gear.

5. The intelligent circulating green making unit according to claim 1, wherein an outer surface of the fourth rotary rocking machine is further provided with a fourth gear ring, the fourth mounting rack is further provided with a fourth driving gear, and the fourth gear ring is meshed with the fourth driving gear.

6. A green making technique of an intelligent circulating green making unit comprising the following steps:
a first rocking; transporting withered tea are to a feeding end of a first rotary rocking machine through a conveying assembly; driving a first driving gear to rotate according to preset rotary time and rotary rate, which in turn drives a first gear ring to rotate, thus starting a first rocking technique of a first rotary rocking machine;
a first photography analysis; taking photos of the tea after the first rocking through a first camera module, sending the photos to a first processor, extracting and analyzing tea color degrees in the photos by the first processor after receiving the photos, comparing and analyzing the extracted and analyzed tea color degree with a preset standard tea color degree finally; if the extracted and analyzed tea color degree is weaker than the preset standard tea color degree, subsequent drying time of a single-layer withering unit will be increased; if the extracted and analyzed tea color degree is higher than the preset standard tea color degree, subsequent drying time of a single-layer withering unit will be reduced;
a first withering; regulating transmission rate of a transmission belt assembly according to a control command issued by the first processor, transporting tea to a first transmission belt assembly on an uppermost layer from a discharge end of the first rotary rocking machine through the conveying assembly after the first transmission belt assembly is regulated, transporting tea to a first transmission belt assembly on a lowest layer through the first transmission belt assembly on the uppermost layer sequentially and transporting tea to a feeding end of a second rotary rocking machine from the first transmission belt assembly on the lowest layer through a conveying assembly;
a second rocking; driving a second driving gear to rotate according to preset rotary time and rotary rate, which in turn drives a second gear ring to rotate, thus starting a second rocking technique of a second rotary rocking machine;
a second photography analysis; taking photos of tea after the second rocking through a second camera module, sending the photos to a second processor; extracting and analyzing tea color degrees in the photos by the second processor after receiving the photos, comparing and analyzing the extracted and analyzed tea color degree is with a preset standard tea color degree finally; if the extracted and analyzed tea color degree is weaker than the preset standard tea color degree, subsequent drying time of a three-layer withering unit will be increased; if the extracted and analyzed tea color degree is higher than the preset standard tea color degree, subsequent drying time of a three-layer withering unit will be reduced;
a second withering; regulating transmission rate of a second transmission belt assembly according to a control command issued by the second processor; after the second transmission belt assembly is regulated, transporting tea to a second transmission belt assembly on an uppermost layer from a discharge end of the second rotary rocking machine through a conveying assembly, transporting tea to a second transmission belt assembly on a lowest layer through the second transmission belt assembly on the uppermost layer sequentially; then lifting tea positioned at the second transmission belt assembly on the lowest layer to a next set of a second transmission belt assembly on an uppermost layer through a lifting assembly, and transporting tea repeatedly to a second transmission belt assembly on a lowest layer from a second transmission belt assembly on an uppermost layer;
a third rocking; driving a third driving gear to rotate according to preset rotary time and rotary rate, which in turn drives a third gear ring to rotate, thus starting a third rocking technique of a third rotary rocking machine;
a third photography analysis; taking photos of the tea after the third rocking through the third camera module, sending the photos to a third processor; extracting and analyzing tea color degrees in the photos by the third processor after receiving the photos; comparing and analyzing the extracted and analyzed tea color degree with a preset standard tea color degree finally; if the extracted and analyzed tea color degree is weaker than the preset standard tea color degree, subsequent rocking time of a fourth rocking unit will be increased or subsequent rocking force of a fourth rocking unit will be enhanced; if the extracted and analyzed tea color degree is higher than the preset standard tea color degree, subsequent rocking time of a fourth rocking unit will be reduced or subsequent rocking force of a fourth rocking unit will be weakened; and
a fourth rocking; regulating rotary rate of a fourth driving gear according to a control command issued by the third processor; transporting tea to a feeding end of the fourth rocking unit from a discharge end of the third rocking unit through a conveying assembly after the rotary rate of the fourth driving gear is regulated, and then driving the fourth driving gear to rotate, which in turn drives a fourth gear ring to rotate, thus starting a forth rocking technique of a forth rotary rocking machine.

7. The green making technique of an intelligent circulating green making unit according to claim 6, wherein the first photography analysis specifically comprises:
if the extracted and analyzed tea color degree is weaker than the preset standard tea color degree by less than three color degrees, standard drying time of the single-layer withering unit shall be increased by 10%; if the extracted and analyzed tea color degree is weaker than the preset standard tea color degree by not less than three color degrees, standard drying time of the single-layer withering unit shall be increased by 30%; and
if the extracted and analyzed tea color degree is higher than the preset standard tea color degree by less than three color degrees, standard drying time of the single-layer withering unit shall be reduced by 20%; if the extracted and analyzed tea color degree is higher than the preset standard tea color degree by not less than three color degrees, standard drying time of the single-layer withering unit shall be reduced by 45%.

8. The green making technique of an intelligent circulating green making unit according to claim 6, wherein the second photography analysis specifically comprises:
if the extracted and analyzed tea color degree is weaker than the preset standard tea color degree by less than three color degrees, standard drying time of the three-layer withering unit shall be increased by 5%; if the extracted and analyzed tea color degree is weaker than the preset standard tea color degree by not less than three color degrees, standard drying time of the three-layer withering unit shall be increased by 25%; and
if the extracted and analyzed tea color degree is higher than the preset standard tea color degree by less than three color degrees, standard drying time of the three-layer withering unit shall be reduced by 8%; if the extracted and analyzed tea color degree is higher than the preset standard tea color degree by not less than three color degrees, standard drying time of the three-layer withering unit shall be reduced by 33%.

9. The green making technique of an intelligent circulating green making unit according to claim 6, wherein the third photography analysis specifically comprises:
if the extracted and analyzed tea color degree is weaker than the preset standard tea color degree by less than three color degrees, standard rocking time or standard rocking force of the fourth rocking unit shall be increased by 15%; if the extracted and analyzed tea color degree is weaker than the preset standard tea color degree by not less than three color degrees, standard rocking time or standard rocking force of the fourth rocking unit shall be increased by 25%; and
if the extracted and analyzed tea color degree is higher than the preset standard tea color degree by less than three color degrees, standard rocking time or standard rocking force of the fourth rocking unit shall be reduced by 28%; if the extracted and analyzed tea color degree is higher than the preset standard tea color degree by not less than three color degrees, standard rocking time or standard rocking force of the fourth rocking unit shall be reduced by 38%.
